(19) United States
(12) Patent Application Publication
(10) Pub. No.: US 2010/0266878 A1
(43) Pub. Date: Oct. 21, 2010

(54) PRISMATIC POLYMER CASE FOR ELECTROCHEMICAL DEVICES

(75) Inventor: Thor E. Eilertsen, Oneonta, NY (US)

Correspondence Address: COOLEY LLP;ATTN: Patent Group, Suite 1100, 777 - 6th Street, NW, WASHINGTON, DC, 20001, US

(73) Assignee: Ioxus, Inc., Oneonta, NY (US)

(21) Appl. No.: 12/424,830

(22) Filed: Apr. 16, 2009

(51) Int. Cl. H01M 2/12; H01M 2/02; H01M 10/50; H01M 2/10

(52) U.S. Cl. 429/53; 429/163; 429/120; 429/186

(57) ABSTRACT

A case structure generally includes a trough shaped base section, a positive end piece, a negative end piece, and a cover section. The trough shaped base section includes a bottom and two side wall members. The positive and negative end piece are disposed at opposite ends of the base section and include an electrically conductive material at least partially embedded within a thermoplastic material. The cover section is disposed on the base section for sealing the prismatic case. The base section and the cover section can be made from, for example, a polymeric material.

### TECHNICAL FIELD

The present invention generally relates to a case structure for electrochemical devices, and more particularly to a prismatic polymer case structure for electrochemical double layer capacitors.

### BACKGROUND INFORMATION

A variety of electrochemical devices are currently being used to store electrical energy and to power industrial and electronic equipment. Secondary batteries, such are lead acid, nickel cadmium (NiCd), nickel hydrogen (NIH₂), nickel metal hydride (NiMH), lithium ion (Li-ion), and lithium ion polymer (Li-ion polymer) are widely used as power source of vehicles, especially oversized or special vehicles, electric apparatus, and other various kinds of industrial equipment, and their demand has steadily increased in recent years. Electric double-layer capacitors have a variety of commercial applications, notably in “energy smoothing” and momentary-load devices. Some of the earliest uses were motor startup capacitors for large engines in tanks and submarines, and as the cost has fallen they have started to appear on diesel trucks and railroad locomotives. More recently they have become a topic of some interest in the green energy world, where their ability to soak up energy quickly makes them particularly suitable for regenerative braking applications, whereas batteries have difficulty in this application due to slow charging rates.

Another example of an energy storage devices that combines battery and capacitor technology is knows as the pseudo capacitor. While electric double-layer capacitors only store energy electrostatically, pseudo capacitors (“P-EDLC”) can also store energy through a chemical reaction whereby a faradic charge transfer occurs between the electrolyte and electrode. Pseudo capacitors are asymmetrical in that one of the two electrodes is a carbon based capacitor electrode while the second electrodes is made from a transition metal oxides similar to those used in secondary batteries. Both of these energy storage mechanisms are highly reversible and can be charged and discharged thousands of times but the electric double-layer capacitors has the greater lifetime capability of millions of charge and discharge cycles.

The advancements in battery and capacitor technologies have also created greater demands on the case structure itself such as, for example, enlargement of the case, diversification of its design, and reduction of weight and thickness, etc. Therefore, further improved qualities such as better moldability, higher strength, higher heat resistance and improved vapor barrier properties have become important design considerations for energy storage device cases.

### SUMMARY OF THE INVENTION

In an effort to reduce the weight of electrochemical devices (particularly in vehicle applications), some cases for these devices (and modules) are being made of plastic. The specific plastics and/or blends/alloys that have been used up to now are chosen for their physical properties, dielectric properties, and chemical resistance to the environment and the electrochemical cell's internal chemistry. Unfortunately, many of these plastics generally have relatively low thermal conductivity, and as such, their use generally places severe limitations on the ability of the devices to be cooled efficiently. Therefore more elaborate systems are needed to provide both the structural integrity and thermal management of the batteries.

It thus would be desirable to provide a new electrochemical device case having excellent mechanical strength, impact resistance, heat resistance, chemical resistance, and high weld strength of welds which have occurred in a molding process, as well as an adhesive strength of welded parts that have been welded to one of the other parts of the case during the assembly process. The electrochemical device case can be used in the fields of electrical and electronic devices, automobiles, and various other industrial products. The electrochemical device generally includes an injection molded body with end aluminum pole plates intimately welded to a multi layered stacked prismatic electrode structure. When used to manufacture electric double layer capacitors, the injection molded case not only enhances the capacitance of the device but also reduces the associated series resistance for enhanced energy and power delivery.

A case structure according to the present invention generally includes a trough shaped base section, a positive end piece, a negative end piece, and a cover section. The trough shaped base section includes a bottom and two side wall members. The positive and negative end piece are disposed at opposite ends of the base section and include an electrically conductive material at least partially embedded within a thermoplastic material. The cover section is disposed on the base section for sealing the prismatic case. The base section and the cover section can be made from, for example, a polymeric material.

In various embodiments, the case structure may further include heat sink inserts disposed in the base section and/or the cover section to help dissipate heat from the electrochemical device. One or both of the end pieces may include an aperture or a valve to purge the device with an inert gas and fill with an electrolyte. The case structure may further include protrusions and recesses, or other alignment features to allow multiple case structures to be stacked on top of one another.

In another aspect, the invention is directed to an electrochemical device comprising a prismatic case structure including a base section, a first end piece disposed at one end of the base section, a second end piece disposed at the opposite end of the base section, and a cover section disposed on the base section for sealing the prismatic case. The first and second end pieces include an electrically conductive material at least partially embedded within a thermoplastic material. An electrode assembly comprising at least two electrodes including a cathode and an anode and a separator separating the at least two electrodes is disposed in the prismatic case structure. The cathode of the electrode assembly is electrically connected to the first end piece and the anode of the electrode assembly is connected to the second end piece. An electrolyte is disposed in the prismatic case structure to saturate the electrode assembly.

In various embodiments, the electrochemical device includes protrusions for exerting positive pressure on the electrode assembly. Alternative, the prismatic case structure includes an inward convex arch for exerting positive pressure on the electrode assembly. The prismatic case structure may include a plurality of ribs for added structural support and/or heat sink inserts to help dissipate heat from the electrochemical device.

### BRIEF DESCRIPTION OF THE DRAWINGS

A fuller understanding of the aspects, objects, features, and advantages of certain embodiments according to the invention will be obtained and understood from the following description when read together with the accompanying drawings, which primarily illustrate the principles of the invention and embodiments thereof. The drawings are not necessarily to scale and like reference characters denote corresponding or related parts throughout the several views. The drawings and the disclosed embodiments of the invention are exemplary only and not limiting on the invention.

FIG. 1 is a perspective view of a representative embodiment of a prismatic case structure in accordance with the present invention.

FIG. 2 is an exploded view of the prismatic case structure shown in FIG. 1.

FIG. 3 is a partially cut-away view of a representative embodiment of an electrochemical double layer capacitor in accordance with the present.

FIG. 4A is an exploded perspective view of a stack of electrodes.

FIG. 4B is a perspective view of a stack of electrodes with two end pole pieces being moved into position at opposite ends of the electrode stack.

FIG. 4C is a perspective view of a stack of electrodes with end pole pieces attached at opposite ends of the electrode stack.

FIG. 4D is a perspective view of the electrode stack of FIG. 4D being inserted into the trough section of a prismatic case structure.

FIG. 4E is a perspective view of a cover being moved into position over the trough section.

FIG. 4F is a perspective view of a fully assembled electrochemical double layer capacitor in accordance with one representative embodiment of the present invention.

FIG. 5A is a perspective view of three prismatic case structure in accordance with the present invention being stacked on top of each other.

FIG. 5B is perspective view of the bottom of one of the case structures shown in FIG. 5A.

FIG. 5C is a perspective view of the three prismatic case structure of FIG. 5A stacked on top of each other.

FIG. 6A is an exploded perspective view of an alternative exemplary embodiment of an electrochemical double layer capacitor in accordance with the present invention.

FIG. 6B is an exploded perspective view of a stacked electrode assembly being made.

FIG. 6C is a perspective view of two stacked electrode assemblies.

FIG. 6D is a perspective view of the two stacked electrodes shown in FIG. 6C with end pole pieces attached at opposite ends of the electrode stack.

FIG. 6E is a cross sectional view of a fully assembled electrochemical device showing the stacked electrode assemblies in the prismatic polymer case.

FIG. 6F is a cross sectional view of a fully assembled electrochemical device showing the stacked electrode assemblies in the prismatic polymer case.

### DESCRIPTION

As indicated above, the present invention relates to a case structure for electrochemical devices and processes for making the case structure. The case structure is generally prismatic in shape and made from injection molded polymers with aluminum end plates. The case structure is sized to allow maximum use of its interior volume such that an electrode assembly fits snugly. The minimized structure allows for more efficient energy transfer, but also reduces the weight and volume of the overall device, thereby increasing the power and energy densities.

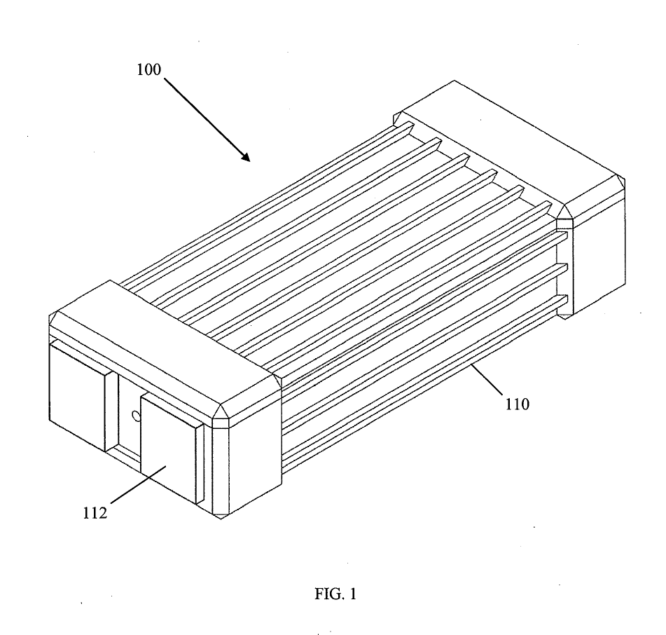

One exemplary embodiment of a case structure in accordance with the present invention is shown in FIG. 1 designated generally by reference numeral 100. The main body 110 of the case 100 can be made from a variety of metals such as, for example, aluminum, plastics, polymers, resins, or combinations thereof, such as, for example, polycarbonate, polyethylene, or polypropylene. The main body 110 houses the electrode assembly of the electrochemical device, therefore, the case material should be lightweight, inexpensive, resistant to solvents such as acetonitrile and/or polycarbonate, and other materials such as ionic salts, and have thermal transfer capability. The case material should also be capable of surviving shock, vibration, and drop conditions in temperature ranges of −55° C. to 80° C., without any puncturing or internal electrode component dismantling. The case 100 also includes end pieces 112 and 114 (not shown) arranged at opposite ends of the main body 110. The end pieces 112, 114 are made from electrically conductive material such as, for example, aluminum. The electrically conductive metal portion of the end pieces 112, 114 are exposed to the outside as well as to the inside of the main body 110 where the electrodes are housed.

In addition to metals, plastics, polymers, and resins, the main body 110 of the case 100 can also be made from a composite mixture including a matrix material with a thermally conductive and/or electrically insulating material distributed throughout the matrix material. The purpose of the thermally conductive, electrically insulating material is to increase the overall thermal conductivity of the mixture used to form the case structure 100. Thus, the thermally conductive, electrically insulating material must be included in a sufficient amount to accomplish this task. On the other hand, too much of the additive will degrade the important physical properties required for producing a useful case 100.

The matrix material may be any of a variety of known materials for forming a plastic housing, and specifically may include at least one polymer selected from the group consisting of polycarbonate, polyethylene, polypropylene, acrylics, vinyl, fluorocarbons, polyamides, polyolefin, polyesters, polyphenylene sulfide, polyphenylene ether, polyphenylene oxide, polystyrene, acrylonitrile-butadiene-styrene, liquid crystal polymers and combinations, mixtures, alloys, or copolymers thereof.

The thermally conductive, electrically insulating material may be distributed within the matrix material in a continuous, discontinuous or mixed mode manner. Examples of discontinuous distributions include particulate or fibrous material. Examples of a continuous distribution include two or three dimensional meshes or mattes.

The mixture may further include a reinforcing material to strengthen the polymer matrix. The reinforcing material preferably is in the form of fibers and is made of at least one of glass, and inorganic minerals.

Examples of suitable thermally conductive, electrically insulating material include calcium oxide, titanium oxide, silicon oxide, zinc oxide, silicon nitride, aluminum nitride, boron nitride, and mixtures thereof.

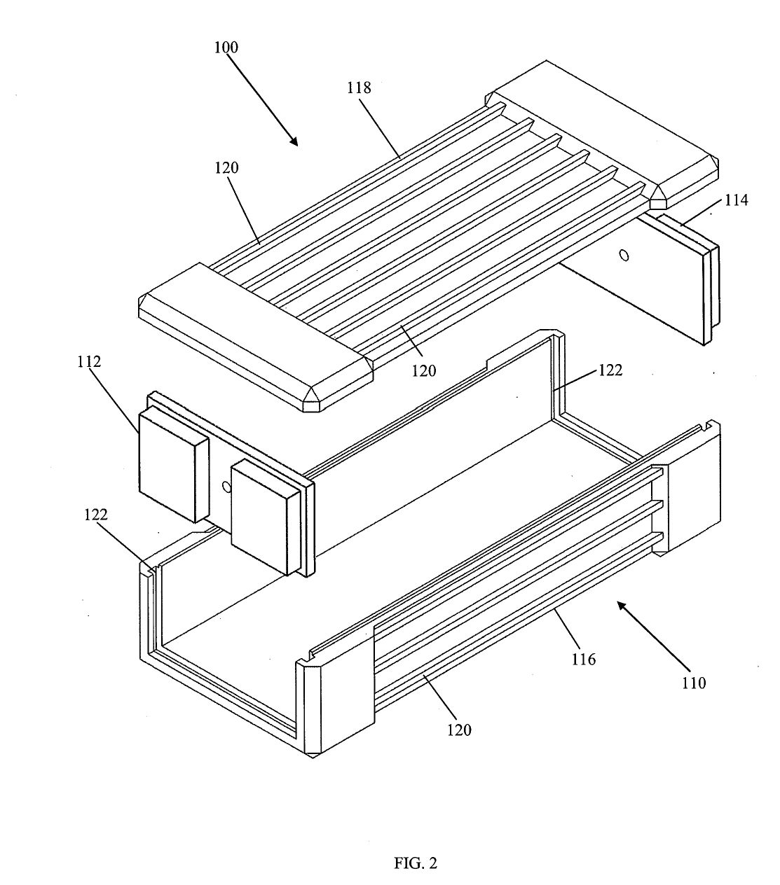

Referring now to FIG. 2, the individual components of the case structure 100 are shown. The main body 110 includes a trough section 116 and a cover 118. A plurality of ribs 120 are formed on the outer surface of the trough 116 and the cover 118 for added structural integrity of the overall case 100. A groove 122 is formed near each end of the trough section 116 to receive the end pieces 112, 114. The trough 116 and cover 118 can be injection molded from a high density polyethylene (HDPE) thermoplastic or similar materials. The injection molding process provides many advantages over other manufacturing methods including, for example, low cost, consistency of parts, scalability, and versatility of design and materials. With the use of modern computerized machining equipment, molds are relatively inexpensive to make and the use of interchangeable inserts and subassemblies, one mold can be used to may make several variations of the same part. This flexibility allows the main body 110 to be easily scaled to accommodate different sized electrochemical devices.

Some molds allow previously molded parts to be reinserted to allow a new plastic layer to form around the first part. This is often referred to as overmolding. This can be achieved by having pairs of identical cores and pairs of different cavities within the mold. After injection of the first material, the component is rotated on the core from the one cavity to another. The second cavity differs from the first in that the detail for the second material is included. The second material is then injected into the additional cavity detail before the completed part is ejected from the mold. This overmolding process can also allow for inserts to be placed between the first and second material to assist with heat dissipation.

As shown in FIG. 2, the main body 110 includes a trough section 116 and a cover 118. However, it will be apparent to one skilled in the art that other shapes, sizes, and configurations of the main body 110 can be used to house the electrode assembly. For example, instead of a trough section 116 and a cover 118, the main body can be made from two identical halves or even from one duct-like piece open at both ends for receiving the electrode assembly.

Referring now to FIG. 3, a partially cut-away electrochemical device 200 (e.g., EDLC or secondary battery) according to one exemplary embodiment of the present invention is shown. The electrochemical device 200 generally includes a main body 210, two end pieces 212 and 214 (not shown) arranged at opposite ends of the main body 210, and a plurality of electrodes 224a, 224b, 224c, etc. disposed in the main body. In the case of an EDLC, the electrodes utilize carbon-carbon bipolar technology for maximum power transfer. In alternative embodiments, the electrodes can include a variety of materials in the case of secondary batteries or can be of an asymmetrical design for pseudo capacitors. A plurality of ribs 220 are formed on the outer surface of the main body 210 for added structural integrity of the overall device 200.

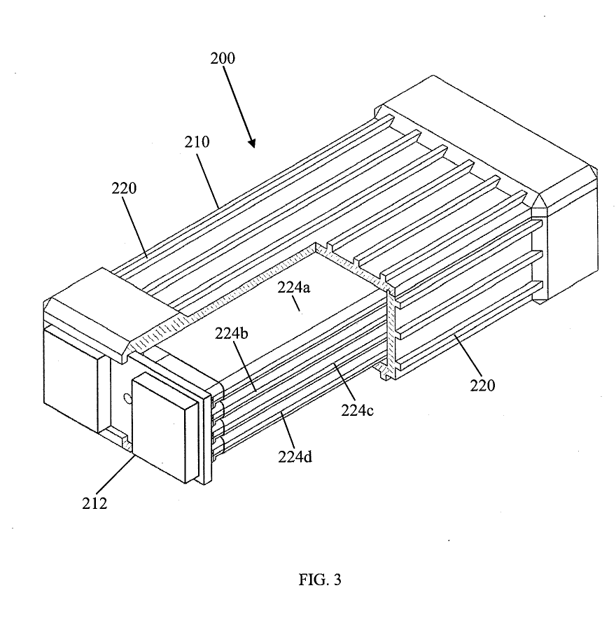

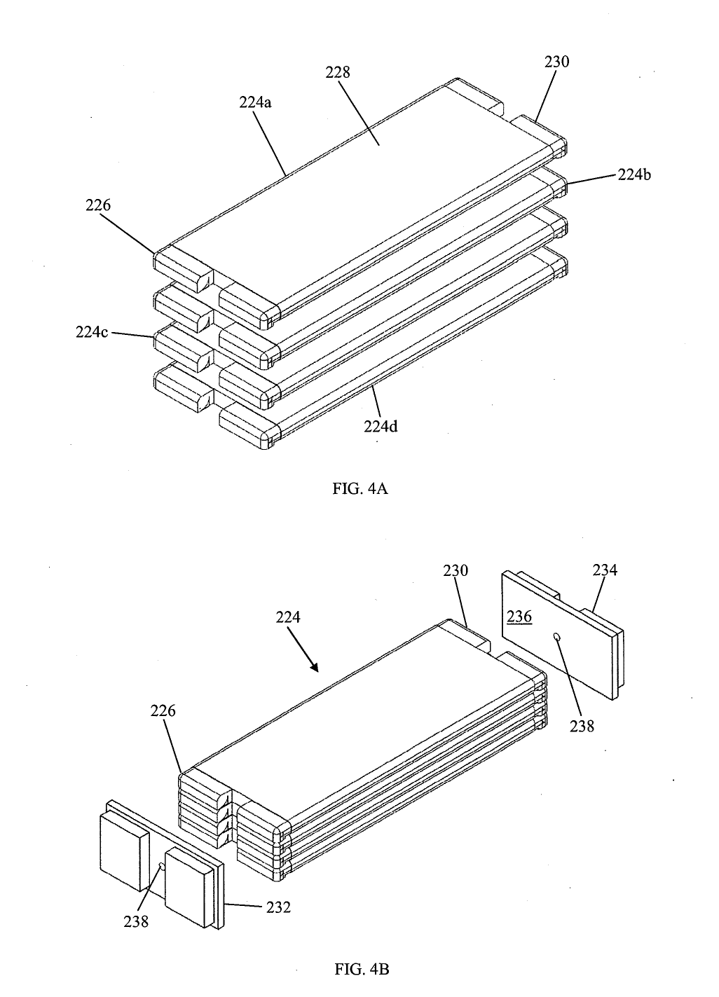

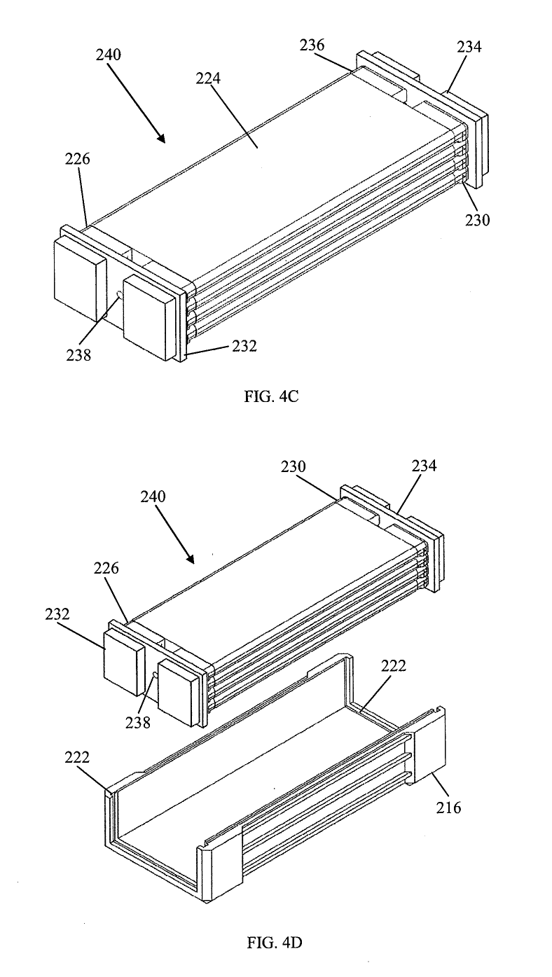

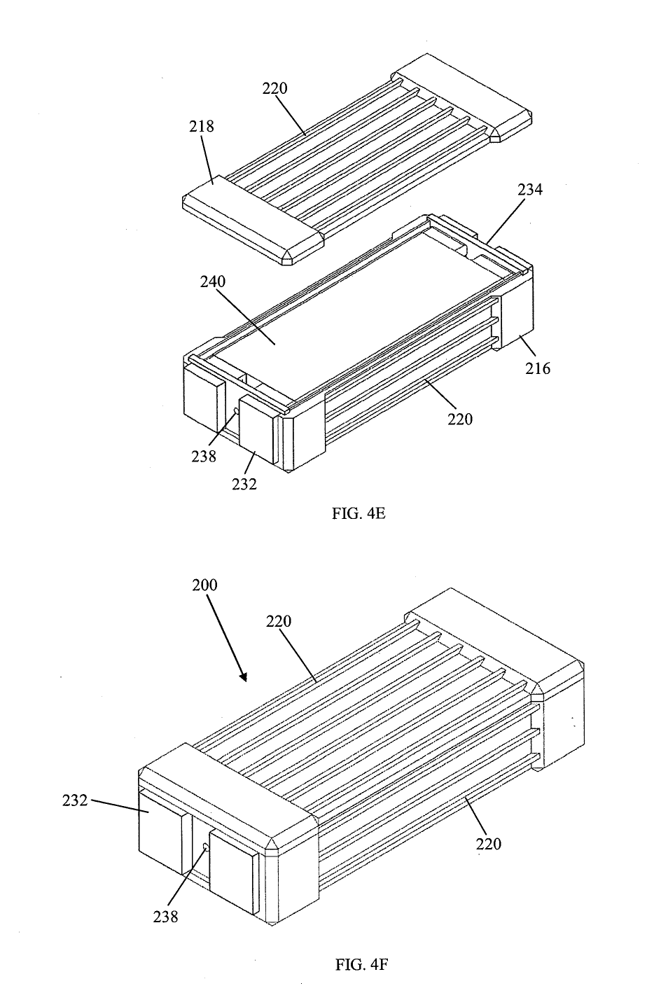

Turning now to FIGS. 4A-4F, assembly of the electrochemical device 200 according to one exemplary embodiment of the present invention is shown. As shown in FIG. 4A, four prismatic electrodes 224a, 224b, 224c, 224d (referred to generically as 224) are being stacked one on top of the other. The electrodes can be made according to many known techniques. For example, in the case of an EDLC, specially formulated activated carbon material, conductive carbon, and other assorted binders and solvents are mixed and processed into a slurry or a paste. After sufficient mixing, the activated carbon mixture is deposited or laminated onto the top and the bottom of an etched aluminum current collector, forming a double-sided electrode.

The double-sided electrode is then trimmed and slit to a specific size, for example, 150 mm×440 mm in the case of a 500 farad EDLC electrode. A proton conductive porous separator (e.g., Celgard 2500) is placed in-between two of these double-sided electrodes, one electrode being the positive side and the other being the negative side, to electrically isolate the two electrodes. The three layers are then prismatically wound together such that a portion of the positive polarity electrode 226 extends beyond the porous separator 228 on one side, and a portion of the negative polarity electrode 230 extends beyond the porous separator 228 on the other side, resulting in a prismatic electrode structure 224. For the purposes of this example, one 500 farad EDLC electrode structure 224 measures approximately 150 mm×55 mm×8 mm. Manufacturing electrode structures for use in EDLCs is described in, for example, U.S. patent application Ser. No. 12/151,811, filed on May 8, 2008, the entirety of which is incorporated herein by reference.

Referring still to FIG. 4A, the four 500 farad electrodes 224a, 224b, 224c, 224d are being stacked one on top of the other so as to have the positive and negative current collectors' mass free zone extension protruding from each end. This type of packaging is sometimes referred to as an extended foil electrode assembly. The stacking of four 500 fared electrodes 224 in this manner results in a 2,000 farad large format EDLC once finally assembled. The number of individual electrodes 224 and the size (i.e., capacitance or dimension) or shape, can vary depending on the particular application for the electrochemical device 200. Adding additional prismatic electrodes 224 increases the capacitance and reduces internal DC resistance because of the ladder structured nature of the carbon electrode. Furthermore, the thickness of the electrode material (e.g., activated carbon mixture) deposited onto aluminum current collector affects the power and energy rating of the electrochemical device 200. For example, for higher power devices, thinner electrode material is used with more prismatic electrode structures such as, for example, 100 farad electrodes. For higher energy structures, thicker electrodes are used.

Referring now to FIGS. 4B and 4C, a positive end piece 232 and a negative end piece 234 are being attached to the stack of electrodes 224 to form an electrode assembly 240 (FIG. 4C). The two end pieces 232, 234 are the same size and thickness and include an electrically conductive material such as, for example, aluminum embedded in a plastic or polymer material (i.e., the same or similar material as the main body of the case structure). The end pieces 232, 234 or pole pieces are injection molded to the designed shape such that the aluminum material is exposed to both the inside and the outside of the package. The injection molding process forms the aluminum and the plastic/polymer material as one piece that is ready to be inserted into the main body of the case. It is envisioned that the packaged EDLC container will not have any end terminals such as screws or nuts such as commonly used in manufacturing today. These devices will slide into a pre-fitted holding box meeting with the end connections and in which there are wedged bolts that seat firmly against the EDLC. This will eliminate excessive contacts that might increase connection resistivity. However, screw and nut end connection terminals that are commonly used in manufacturing today can also be used.

The inside surface 236 (FIG. 4B) of the two end pole pieces 232, 234 are sonically or thermally welded the extended foil electrodes 226, 230 creating an electrical and physical connection. This will allow transfer of the cells energy to the outside of the case very efficiently. Prior to attachment of the end piece to the electrode, the surface of each end of the electrodes (both positive and negative) can be supplemented with a copper, aluminum, or alloy arc spray material which will adhere to the aluminum creating a larger formable mass volume area.

As best shown in FIG. 4B, each of the end pieces 232, 234 also includes an aperture 238 for electrolyte fill. Having two apertures 238, one at each end of the device 200, allows for push-pull de-airing, thus evacuating all of the internal air and purging with an inert gas such as, for example, nitrogen to decontaminate the package. This push-pull system allows both pressure and suction to be applied to the package thereby forcing the liquid electrolyte into the package saturating the electrodes 224. After the air is purged and the electrodes are sufficiently saturated with electrolyte, the apertures 238 can be closed with a screw plug or any of a variety of known closures. Alternatively, unidirectional or bidirectional valves can be disposed in one or both of the apertures 238 to enable purging and electrolyte filling.

Referring now to FIG. 4D-4F, the electrode assembly 240 is being inserted into the trough section 216 of the main body 210 (FIG. 4D). A groove 222 is formed near each end of the trough section 216 to receive the end pieces 232, 234 of the electrode assembly 240. The cover 218 is placed onto the trough section 216 (FIG. 4E) and can have a conforming shape to make sealing the case simpler with fewer seam joints. After the cover 218 is properly aligned with the trough section 216, all of the seams are sonically or thermally welded creating a fully assembled device 200 (FIG. 4F) ready to be purged and filled with electrolyte. As described above, the trough section 216 and cover 218 are injection molded from high density polyethylene (HDPE) thermoplastic or similar material. The trough section 216 is sized to allow maximum use of its interior volume such that the electrode assembly 240 fits snugly. The minimized structure allows for more efficient energy transfer, but also reduces the weight and volume, thereby increasing the power and energy densities. A plurality of ribs 220 are formed on the outer surface of the trough 216 and the cover 218 for added structural integrity of the overall device 200.

In alternative embodiments, interior portions of the trough 216 and/or the cover 218 can have one or more protrusions (not shown) or inserts (not shown) that apply to pressure to the electrode assembly 240 once the device 200 is fully assembled. Alternatively, the interior surfaces of the trough 216 and/or the cover 218 can be slightly convex toward the interior space to apply to pressure to the electrode assembly 240.

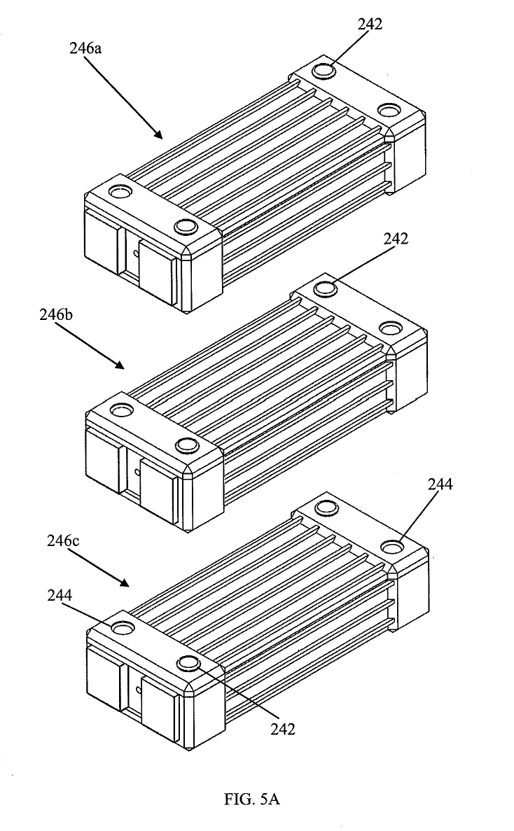

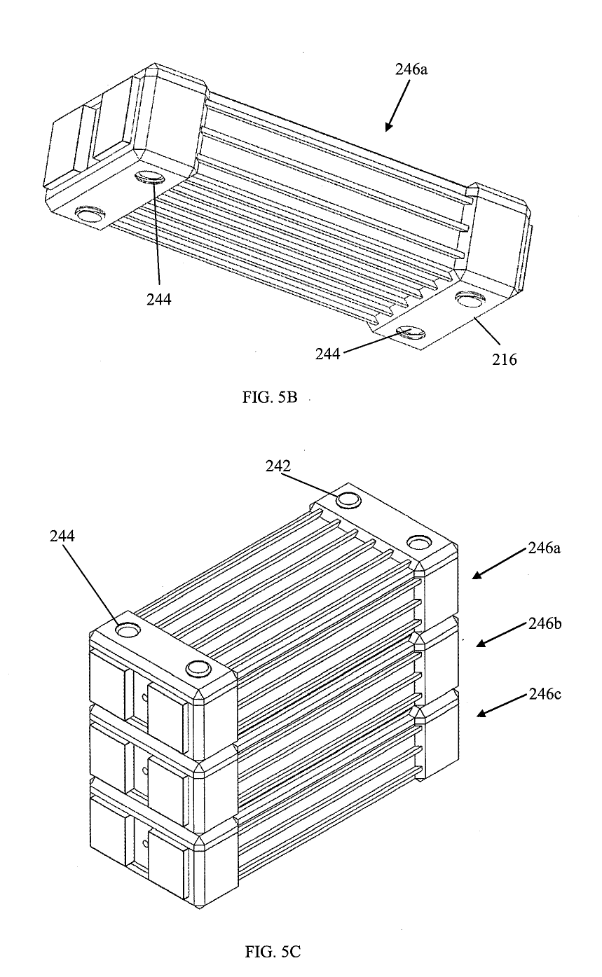

Referring now to FIGS. 5A-5C, in a further exemplary embodiment, the exterior of the trough 216 (FIG. 5B) and cover include a plurality of protrusions 242 and recesses 244 to facilitate the stacking of multiple devices 246a, 246b, 246c. As one device 246a is lowered onto a second device 246b, the protrusions 242 of the second device 246b are received into the recesses 244 of the first device 246a. The result is closely aligned stack (FIG. 5C) of devices 246a, 246b, 246c that provides spacing for heat dissipation and resists movement of individual devices with respect to each other.

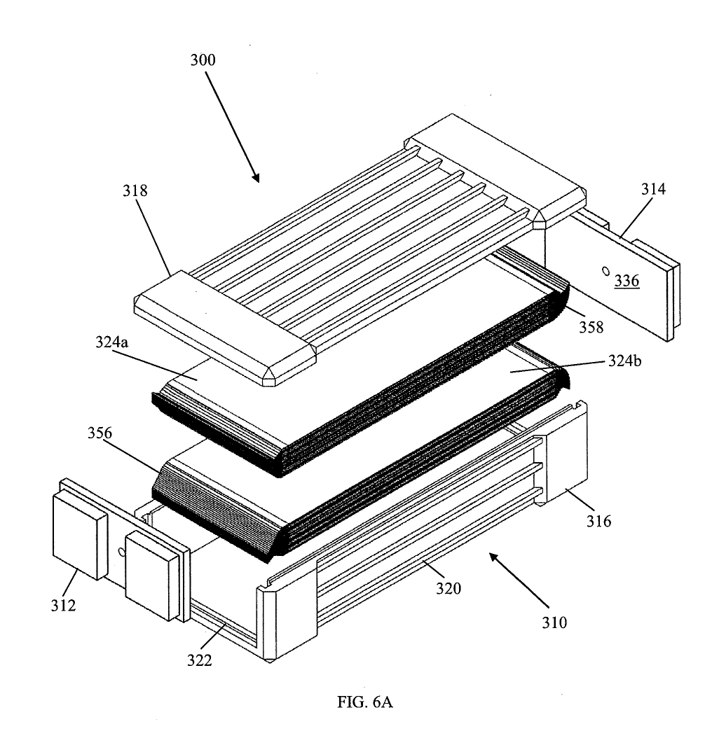

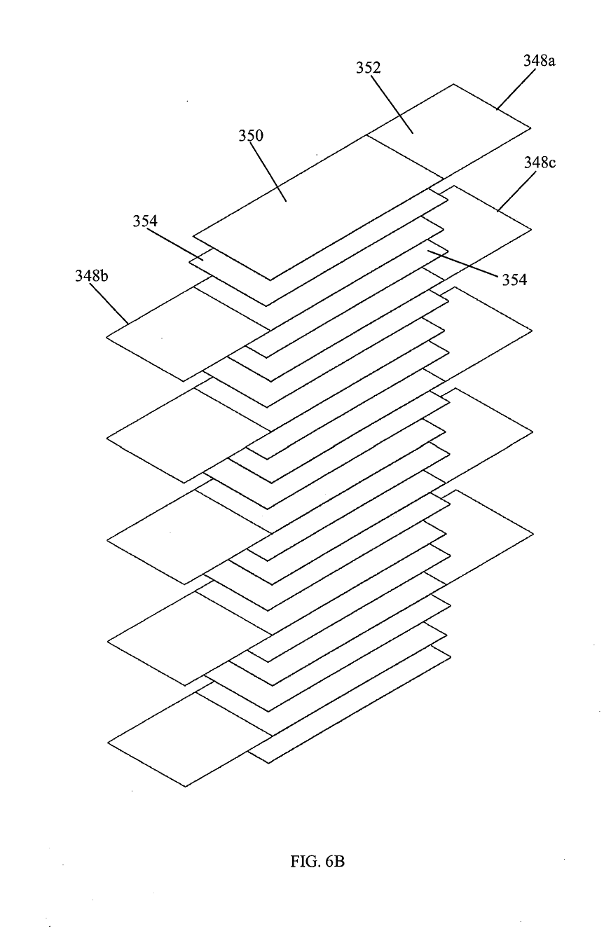

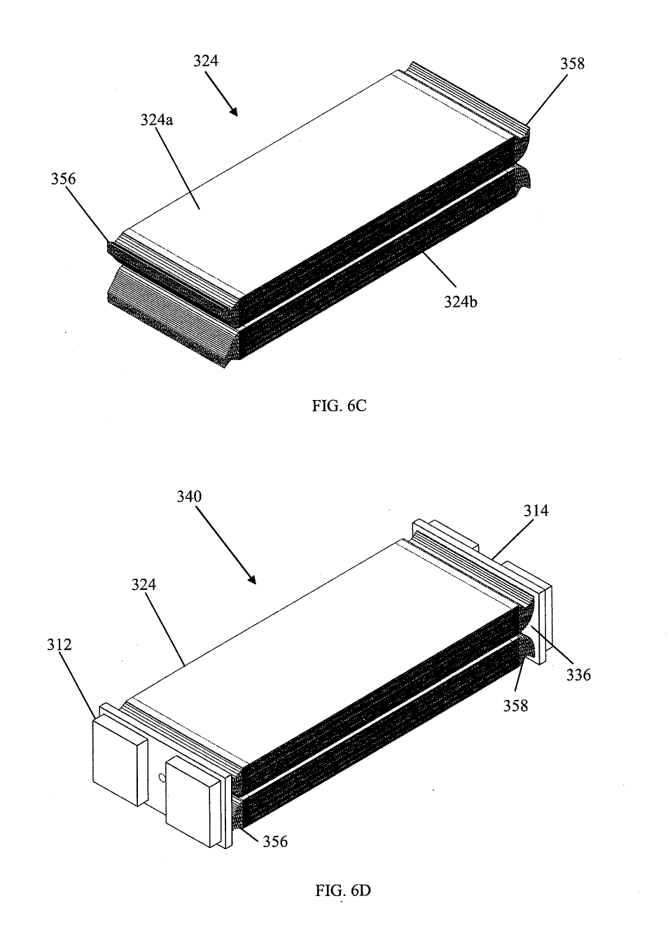

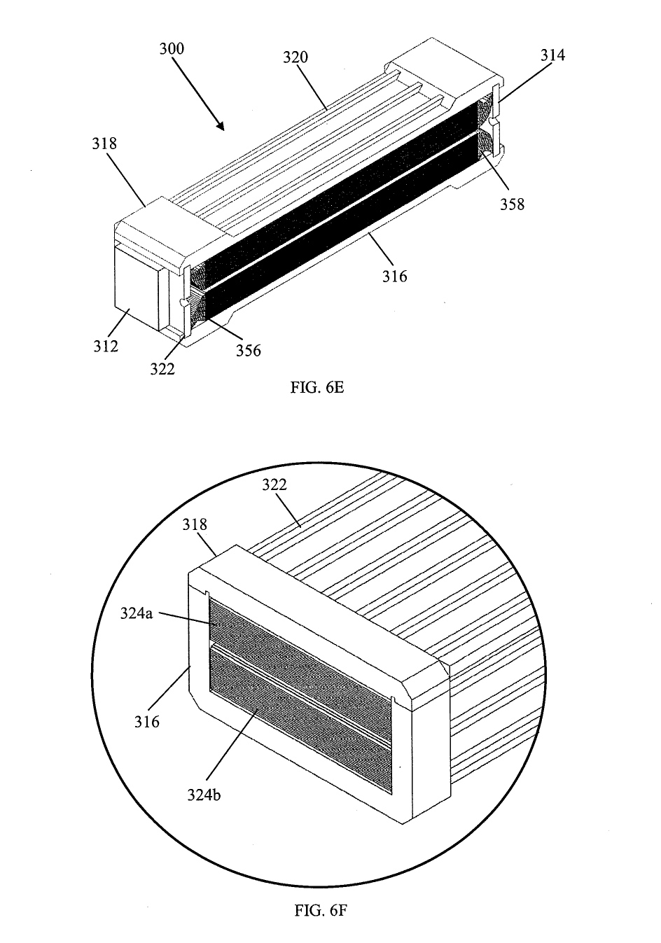

Referring now to FIGS. 6A-6F, a electrochemical device 300 according to an alternative embodiment of the present invention is shown. The electrochemical device 300 performs substantially the same function as the electrochemical device 200 described above, and therefore like reference numerals preceded by the numeral “3” are used to indicate like elements.

As shown in FIG. 6A, the electrochemical device 300 generally includes a main body 310 having a trough section 316 and a cover 318, two end pieces 312 and 314 arranged at opposite ends of the main body 310, and one or more stacks of electrodes 324a, 324b (collectively 324) disposed in the main body 310. A plurality of ribs 320 can be formed on the outer surface of the main body 310 for added structural integrity of the overall device 300.

Referring now to FIG. 6B, stacked electrodes 324 are shown being made according to an alternative exemplary embodiment of the present invention. First, to manufacture electrodes for use in an EDLC, specially formulated activated carbon material, conductive carbon, and other assorted binders and solvents are mixed and processed into a slurry or a paste and then deposited onto the top and the bottom of an etched aluminum current collector, forming a double-sided electrode. The double-sided electrode is then trimmed and slit to a specific size, for example, 150 mm×55 mm, forming individual sheets 348a, 348b, 348c, etc (referred to generally as 348). Each sheet 348 includes a coated portion 350 and an uncoated portion 352. After the sheets 348 have been cut to size, they are then stacked, one on top of each other, in an alternating fashion such that the uncoated portion 352 protrudes from opposite ends of the stack. A porous separator 354 is placed in-between each sheet 348 to electrically isolate each electrode. The uncoated portion 352 of each double-sided electrode protruding from the ends of the stack forms a positive side and a negative side of a stacked electrode structure.

FIG. 6C illustrates two fully assembled stacked electrode structures 324a and 324b stacked one on top of the other with the positive 356 and negative 358 current collectors' mass free zone extension protruding from opposite ends. The number of individual electrodes 324 and the size (i.e., capacitance or dimension) or shape, can vary depending on the particular application for the electrochemical device 300. Adding additional prismatic electrodes 324 increases the capacitance and reduces internal DC resistance because of the ladder structured nature of the carbon electrode. Furthermore, the thickness of the electrode material (e.g., activated carbon mixture) deposited onto aluminum current collector affects the power and energy rating of the electrochemical device 300. For example, for higher power devices, thinner electrode material is used with more prismatic electrode structures such as, for example, 100 farad electrodes. For higher energy structures, thicker electrodes are used.

Referring now to FIG. 6D, a positive end piece 312 and a negative end piece 314 are shown attached to the stack of electrodes 324 to form an electrode assembly 340. The positive 356 and negative 358 current collectors' mass free zone extension protruding from opposite ends of the stacked electrodes 324 are curled up or down and then sonically or thermally welded to the inside surface 336 of the two end pole pieces 312, 314 creating an electrical and physical connection. This will allow transfer of the cells energy to the outside of the case very efficiently. Prior to attachment of the end piece to the electrode, the surface of each end of the electrodes (both positive and negative) can be supplemented with a copper, aluminum, or alloy arc spray material which will adhere to the aluminum creating a larger formable mass volume area.

Referring now back to FIG. 6A, after the electrode assembly 340 is attached to the end pieces 312, 314 as described above, it can be inserted into the trough section 316. A groove 322 is formed near each end of the trough section 316 to receive the end pieces 312, 314 and the cover 318 is placed onto the trough section. After the cover 318 is properly aligned with the trough section 316, all of the seams are sonically or thermally welded creating a fully assembled electrochemical device 300. FIGS. 6E and 6E are cross sectional views of a fully assembled electrochemical device 300 showing the stacked electrode assemblies in the prismatic polymer case.

The disclosed embodiments are exemplary. The invention is not limited by or only to the disclosed exemplary embodiments. Also, various changes to and combinations of the disclosed exemplary embodiments are possible and within this disclosure.

What is claimed is:

1. A prismatic case structure for electrochemical devices comprising:
a trough shaped base section including a bottom and two side wall members,
a positive end piece and a negative end piece disposed at opposite ends of the base section, each of the end pieces including an electrically conductive material at least partially embedded within a thermoplastic material; and
a cover section disposed on the base section for sealing the prismatic case.

2. The prismatic case structure of claim 1, wherein the base section includes a polymeric material.

3. The prismatic case structure of claim 1, wherein the cover section includes a polymeric material.

4. The prismatic case structure of claim 1, wherein the base section includes at least one heat sink insert.

5. The prismatic case structure of claim 1, wherein the cover section includes at least one heat sink insert.

6. The prismatic case structure of claim 1, wherein at least one of the end pieces includes a valve.

7. The prismatic case structure of claim 1, wherein both of the end pieces includes a valve.

8. The prismatic case structure of claim 1, wherein the base section includes protrusions, and the cover section includes recesses to all allow multiple case structures to be stacked on top of one another.

9. The prismatic case structure of claim 1, wherein the base section or the cover section includes a plurality of ribs for added structural support.

10. An electrochemical device comprising:
a prismatic case structure including a base section, a first end piece disposed at one end of the base section, a second end piece disposed at the opposite end of the base section, and a cover section disposed on the base section for sealing the prismatic case, each of the first and second end pieces including an electrically conductive material at least partially embedded within a thermoplastic material;
an electrode assembly disposed in the prismatic case structure, the electrode assembly comprising at least two electrodes including a cathode and an anode and a separator separating the at least two electrodes, wherein the cathode is electrically connected to the first end piece and the anode is connected to the second end piece; and
an electrolyte disposed in the prismatic case structure to saturate the electrode assembly.

11. The electrochemical device of claim 10, wherein the prismatic case structure includes protrusions for exerting positive pressure on the electrode assembly

12. The electrochemical device of claim 10, wherein the prismatic case structure includes an inward convex arch for exerting positive pressure on the electrode assembly.

13. The electrochemical device of claim 10, wherein the prismatic case structure includes a plurality of ribs for added structural support.

14. The electrochemical device of claim 10, wherein the prismatic case structure includes a polymeric material.

15. The electrochemical device of claim 14, wherein the prismatic case structure includes at least one heat sink insert.
